(19) United States
(12) Patent Application Publication
(10) Pub. No.: US 2016/0372013 A1
(43) Pub. Date: Dec. 22, 2016

(54) DEVICE FOR BRIDGE RAILS OR ROADSIDE DECORATIONS AND PUBLICITY

(71) Applicant: Young Jin BAE, Gyeongsangbuk-do (KR)

(72) Inventor: Young Jin BAE, Gyeongsangbuk-do (KR)

(21) Appl. No.: 14/819,377

(22) Filed: Aug. 5, 2015

(30) Foreign Application Priority Data
Jun. 16, 2015 (KR) 10-2015-0085093

(51) Int. Cl. G09F 7/18; G09F 23/00

(52) U.S. Cl. CPC G09F 7/18; G09F 23/00; G09F 2007/1843; G09F 2007/1856

(57) ABSTRACT

The present invention provides a device for bridge rails or roadside decorations and publicity comprising: a support pipe 10 vertically installed by a concrete c by digging the earth to a predetermined depth; an insertion rack 20 connected and fixed to the upper end of the support pipe 10 for inserting an advertisement frame or a safety indication plate or a direction indication plate; and an advertisement frame 30 able to be inserted into the insertion rack 20 while being inserted with a publicity plate or an advertisement plate 30a.

The present invention constructed as such has many effects that it is installed at the bridge rails, guard rails or the roadside so as to naturally publicize special products, sightseeing areas, vestiges of a district and various goods or services, and in particular, the installation angle of the advertisement frame 30 can be adjusted so as to be easily noticed by the pedestrians, car drivers or passengers so as to maximize the effect of the publicity and advertisement, and in addition, the advertisement plate 30a can be very easily replaced so that the replacement of the advertisement plate 30a and the facility management according to various activities of the local governments can also be easily done, and the reliability is maximized.

### BACKGROUND

(a) Technical Field

The present disclosure relates to a device for bridge rails or roadside decorations and publicity which can be installed at various places such as the bridge rail, the roadside, or the roadside guard rail so as to rapidly and conveniently install the decoration using the artificial flower or natural flower, the publicity material such as guide indication plate guiding the road situation, and to easily install and replace the advertisement material publicizing the special products, sightseeing areas, vestiges of a district and activities of the local government, and which makes the advertisement material to be installed so that the publicity content can be easily recognized even by the car drivers and passengers in the car during travelling.

(b) Background Art

As is widely known, the local government such as city, province, county, ward and the like installs the publicity panel publicizing the special goods such as the special products, sightseeing areas, vestiges of a district at the roadside, guard rail or rail or the wall of the building, and in particular, installs various safety indication plates including the reflection plate at the bridge rail or the guard rail of the roadside so as to prevent the accident.

In addition, the local government or various enterprises selects special season or day and plans various events or activities, and at this time, advertises or publicizes by preparing other publicity panel to publicize the events or activities.

Therefore, when performing various publicity as described above, the facilities according to the publicity are increased and accordingly the expenditure is required, and furthermore, the environment is damaged due to the installation of many publicity material.

In particular, modern human using the car as necessities of life has the tendency of using the car even for the short distance, and since even long distance can be reached rapidly without problem due to the travel with the car, if a device is provided which enables the passengers and drivers to easily recognize or identify the particular advertisement or the publicity material during travelling with the car, then the effect of the advertisement and the publicity can be further increased.

SUMMARY OF THE DISCLOSURE

Therefore, an object of the present invention is to provide a device for bridge rails or roadside decorations and publicity which can be installed at the bridge rail, guard rail or the roadside so as to efficiently decorate the rail, guard rail and the roadside, and which makes the publicity panel indicating the special products, sightseeing areas, vestiges of a district and activities plan and the like to be easily attached and removed so as to replace the publicity panel or change the installation at any time according to the road situation or the activities, and furthermore, which can easily adjust and install the publicity panel or the guide indication plate such as the traffic indication plate to the angle which makes them to be easily noticed by the pedestrians, car drivers or passengers during the car progress procedure.

In addition, other object of the present invention is to construct the transverse pipe composing the bridge rail as the insertion pipe on which upper and lower and large and small holes are drilled so as to be opened to each other, so that the various artificial flowers, natural flowers, flags or publicity plate for various activities can be selectively installed.

The device for bridge rails or roadside decorations and publicity to accomplish the objects described above is composed by the following structure.

\textcircled{1} In constructing the device for bridge rails or roadside decorations and publicity,

the publicity device 100 comprises: a support pipe 10 vertically installed by a concrete c by digging the earth to a predetermined depth; an insertion rack 20 connected and fixed to the upper end of the support pipe 10 for inserting an advertisement frame or a safety indication plate or a direction indication plate; and an advertisement frame 30 able to be inserted into the insertion rack 20 while being inserted with a publicity plate or an advertisement plate 30a,

wherein at the insertion rack 20, plural insertion holes 21 consistent with each other at the upper surface and the lower surface of the insertion rack body in the form of rectangular pipe so as to insert artificial flowers and the like, and insertion holes 22 for inserting insertion rods 31 of the advertisement frame 30 are drilled at the upper surface and the lower surface, and connection pipes 23 which can be connected to the upper end of the support pipe are formed at both sides of the bottom surface of thereof, and a slider 24 sliding transferred along the insertion rack 20 and having insertion holes 24′ for inserting insertion rods 31′ of the advertisement frame 30 is installed, and

wherein the advertisement frame 30 is provided, at the lower side of the support panel 32 having upper and lower insertion parts 32a, 32a′ so as to insert the advertisement plate 30a formed in a predetermined shape by pushing the advertisement plate from side to side, with insertion rods 31, 31′ to be inserted into the insertion holes 22 formed at the insertion rack body and the insertion holes 24′ formed at the slider 24, and a latch protrusion 33a and a fixing hole 33b are formed at the lower part of the insertion rods 31, 31′, so that the insertion rods are inserted into the insertion holes 22 and the insertion holes 24′ and thereafter a pin is inserted into the fixing hole 33b whereby the publicity device is stably assembled.

\textcircled{2} The insertion rack 20 formed in a rectangular pipe and perforated with plural insertion holes 21 for inserting artificial flowers, natural flowers or the insertion rods 31 of the advertisement frame 30 is installed and used as an upper pipe composing a bridge rail B.

\textcircled{3} When the sliders 24 having plural insertion holes 24′ at both sides of the insertion rack 20 are installed at one roadside or a center division pedestal or a bridge rail B, the advertisement contents can be recognized by the cars coming from one travelling direction lane as well as the cars coming from the opposite lane.

\textcircled{4} The slider 24 is composed of the support bar 24a having plural insertion holes 24′, and the transfer rack 24c at which a hinge hole h is drilled so that the forward end of the support bar 24a is inserted and assembled with bolt 24b and nut 24b′, and which at the same time is moved left and right and adjusted along the insertion rack body, so that the support bar 24a can be angularly adjusted left and right with the bolt 24b as a center of rotation.

\textcircled{5} The support bar 24a is formed in a round shape.

\textcircled{6} The transfer rack 24c of the slider 24 is formed in “⊥” shape, and fix holes h′ for fixing the support bar 24a are drilled at the forward end and left and right parts with the hinge hole h formed at the center part as the center, and a hinge hole h1 which is assembled to the hinge hole h with bolt 24b and a fix hole h1′ consisting to the fix holes h′ are drilled at the support bar 24a, too, and the support bar 24a can be adjusted left and right with bolt 24b and nut 24b′ as the center and can be arranged parallel to the insertion rack body or in T shape by the fix holes h′, h1′.

\textcircled{7} The rear part of the transfer rack 24c of the slider 24 is formed in a form of circular arc, and plural fix holes h′ are formed in a form of circular arc with the hinge hole h formed at the center part as the center, and at the same time, a hinge hole h1 and a fix hole h1′ respectively consisting to the hinge hole h and the fix hole h′ are formed at the forward end of the support bar 24a so as to be angularly adjusted by bolt 24b and nut 24b′.

\textcircled{8} Connection pipes 23 mounted at the insertion rack 20 are integrally formed with the slide pipes 23a so as to be moved left and right and holes 23h, 10a which are opened to each other are drilled and connected and fixed by connection member 23 composed of bolt and nut, so that the slide pipe 23a is adjusted according to the installation spacing of the pair of support pipes 10, 10′ so as to be easily assembled and mounted.

\textcircled{9} The connection pipes 23 are hinged to the slide pipes 23a so as to be able to be adjusted and installed.

\textcircled{10} A fix hanger 25 which can be inserted into and connected to the upper end of the guide rail G is provided at both sides of the front surface of the insertion rack 20.

\textcircled{11} An insertion rack 40 having plural insertion holes 41 for inserting the artificial flower is further mounted at the back side upper end of the advertisement frame 30.

\textcircled{12} When the insertion holes 21, 22 of the insertion rack 20 used as the upper end pipe of the bridge rail and the insertion holes 41 of the insertion rack 40 are formed in such a way that the upper hole is made wide and the lower hole is made narrow.

\textcircled{13} At the time of installing at the roadside, a connection rack 50 having plural insertion holes 51 is provided between the insertion rack 20 and the insertion rack 20.

\textcircled{14} The insertion rack 20 and the connection rack 50 are connected with a connection piece 52 such as a rectangular connection pipe or a shape socket and the like or with a socket 53 which is made by enlarging both ends of the connection rack 50, and when connecting by using the connection piece 52 or the socket 53, the connection is done by bolt, nut or riveting.

\textcircled{15} The insertion rack 20 used as a transverse bar of the bridge rail B is in the form of a hexagonal or circular pipe.

The insertion rack 20 is filled with foam urethane or styrofoam therein.

Flowerpots P are connected by using a connection rack c1 and mounted at the insertion rack 20 installed as an upper end pipe of the bridge rail B so as to plant ornamental trees including herbaceous flowering plants, so as to enable the planting of the plant and at the same time to enable the inserting of the advertisement frame 30 at which various indication plate, or the guide plate or publicity plate can be installed.

The insertion rack 20 and the flowerpot P are composed integrally, and the slide recess S1 is formed between the insertion rack 20 and the flowerpot P, and support pipes 10d are provided at the bottom of the flowerpot P body or the fix hanger 25 is provided so as to be able to be hung to the guard rail G at both sides of the front surface.

A net M is installed at the upper surface and the lower surface of the insertion rack 20 and the slide 24 so that the artificial flower, natural flower, the guide plate 30c or insertion rods 31, 31′ of the support panel 32 can be stably inserted and supported.

(Effect of the Present Invention)

The present invention constructed as such has many effects that it is installed at the rail of the elevated road or the bridge or the roadside or the center division pedestal so as to maximize the decoration of various artificial flowers or natural flowers as well as to naturally publicize special products, sightseeing areas, vestiges of a district and various goods or services, and in particular, the installation angle of the advertisement frame 30 can be adjusted so as to be easily noticed by the pedestrians, car drivers or passengers so as to maximize the effect of the publicity and advertisement, and in addition, the advertisement plate 30a can be very easily replaced so that the replacement of the advertisement plate 30a and the facility management according to various activities of the local governments can also be easily done, and the reliability is maximized.

### BRIEF DESCRIPTION OF THE DRAWINGS

FIGS. 1 to 9 show one embodiment of the present invention;

FIG. 1 is an exploded perspective view;

FIG. 2 is a top view exemplary drawing showing an action condition;

FIG. 3 is a front view exemplary drawing showing a condition of exploding a support pipe and an insertion rack;

FIG. 4 is a side view exemplary drawing;

FIG. 5 is a main part enlarged sectional view exemplary drawing showing a condition where the insertion rods are inserted to the insertion rack;

FIG. 6 is a main part enlarged sectional view exemplary drawing of an advertisement frame;

FIG. 7 is a main part front view exemplary drawing showing other embodiment of a connection pipe of the present invention;

FIG. 8 shows a condition of assembling the insertion rack and a connection rack of the present invention by a connection piece;

FIG. 9 is a drawing showing a condition of use of the present invention;

FIGS. 10 and 11 show a second embodiment of the present invention;

FIG. 10 is a main part exploded perspective view of the insertion rack;

FIG. 11 is a top view exemplary drawing showing an action condition of the insertion rack;

FIG. 12 is a main part top view exemplary drawing showing a third embodiment of the present invention;

FIGS. 13 and 14 show a fourth embodiment of the present invention;

FIG. 13 is a main part exploded perspective view;

FIG. 14 is a top view exemplary drawing showing an action condition;

FIGS. 15 and 16 show a fifth embodiment of the present invention;

FIG. 15 is a main part exploded perspective view;

FIG. 16 is a top view exemplary drawing showing an action condition;

FIG. 17 is a perspective view showing a condition where the present invention is applied to bridge rails as a sixth embodiment of the present invention;

FIGS. 18 and 19 are perspective views showing a seventh embodiment of the present invention;

FIG. 20 is a perspective view showing an eighth embodiment of the present invention;

FIGS. 21 to 23 are perspective views showing a ninth embodiment of the present invention; and

FIG. 24 is a perspective view showing a tenth embodiment of the present invention.

### DETAILED DESCRIPTION

The present invention is a device for bridge rails or roadside decorations and publicity which can be installed at the roadside of the national road or the local road and various places such as sightseeing areas, vestiges and parks, and the advertisement plate 30a can be easily replaced in consideration of various activities plans and memorial days of the local governments, and the angle of the advertisement frame 30 mounted with the advertisement plate 30a can be very easily adjusted so that the eyes of the car drivers, passengers or pedestrians can be comfortably and naturally directed to the advertisement plate, and construction and management can be conveniently accomplished, and will be described in detail with reference to the accompanying drawings as follows.

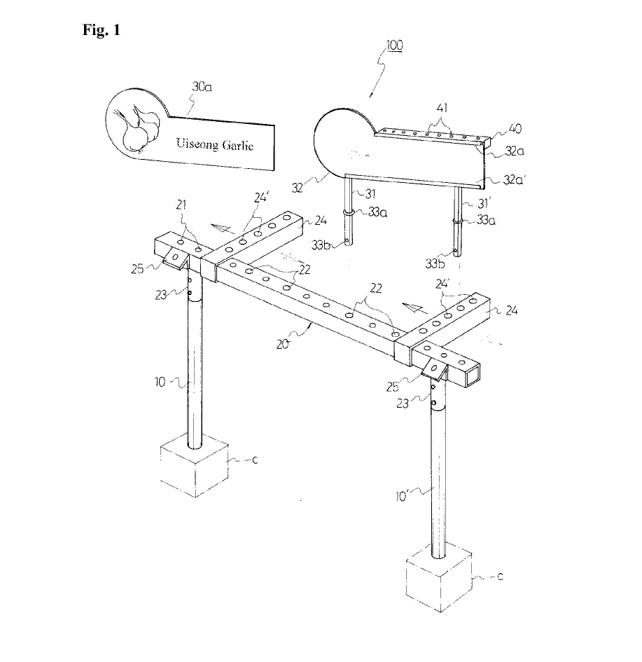

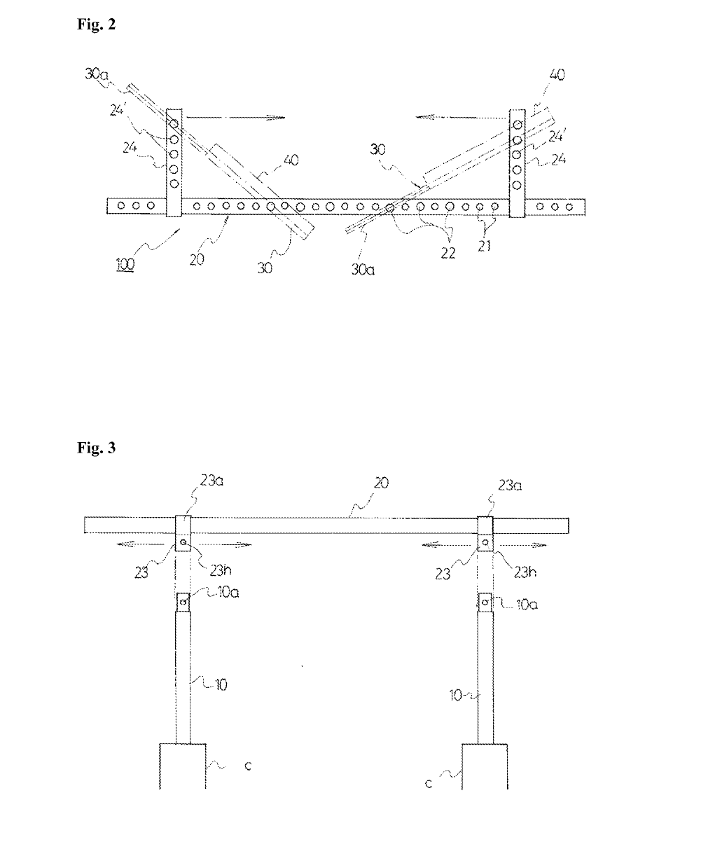

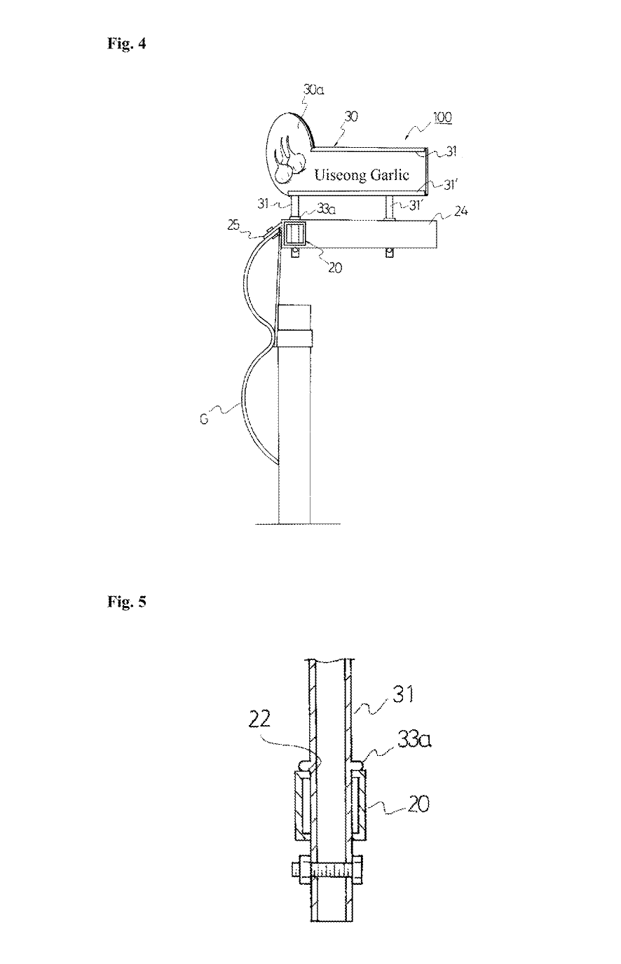

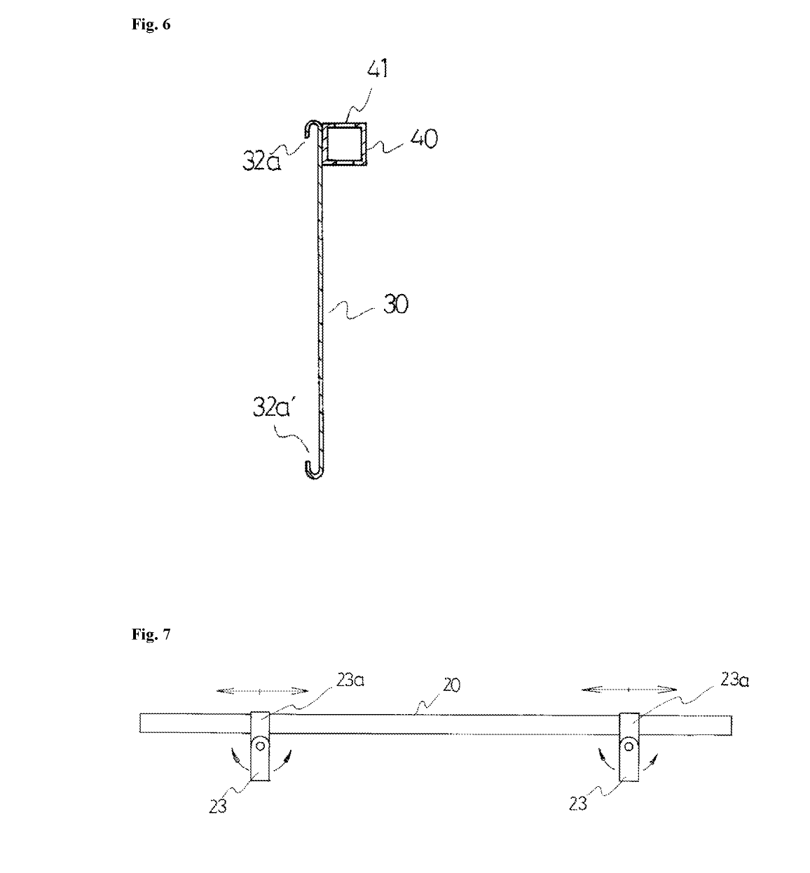

FIGS. 1 to 6 show one embodiment of the present invention, wherein FIG. 1 is an exploded perspective view, FIG. 2 is a top view exemplary drawing showing an action condition, FIG. 3 is a front view exemplary drawing showing a condition of exploding a support pipe and an insertion rack, FIG. 4 is a side view exemplary drawing, FIG. 5 is a main part enlarged sectional view exemplary drawing showing a condition where the insertion rods are inserted to the insertion rack, and FIG. 6 is an enlarged longitudinal sectional view exemplary drawing of an advertisement frame.

As can be seen in the accompanying drawings FIGS. 1 to 6, a roadside installation publicity device 100 comprises: a support pipe 10 vertically installed by a concrete c by digging the earth to a predetermined depth; an insertion rack 20 connected and fixed to the upper end of the support pipe 10 for inserting an advertisement frame or a safety indication plate or a direction indication plate; and an advertisement frame 30 able to be inserted into the insertion rack 20 while being inserted with a publicity plate or an advertisement plate 30a.

The insertion rack 20 is in the form of rectangular pipe, and plural insertion holes 21 are drilled at the upper surface and the lower surface so as to be consistent at the upper surface and the lower surface with a predetermined spacing so as to insert a variety of kinds of artificial flowers, and insertion holes 22 for inserting insertion rods 31 of the advertisement frame 30 are drilled at predetermined places of the insertion rack 20 at appropriate number of places.

In addition, all the insertion holes drilled at the insertion rack 20 may be formed to have an identical size, and at this time the size may be formed to be able to insert the insertion rods 31 of the advertisement frame 30 so as to insert the insertion rods 31 or the artificial flowers or the natural flowers into the insertion holes.

In addition, connection pipes 23 are formed at both sides of the lower surface of the insertion rack 20 so as to connect to the upper end of the support pipes 10, 10′ which are erected and fixed vertically by using the concrete c, and the connection pipes 23 are assembled and settled at the upper end of the support pipes 10, 10′ and then fixed secure by means of welding or connection members such as bolts and nuts.

In particular, since the present invention is provided with a slider 24 having plural insertion holes 24′ at the rear side of the insertion rack 20, the advertisement frame 30 can be installed by moving the slider 24 left and right according to the distance between the slider 24 and the insertion rods 31 provided at the advertisement frame 30, and in addition, there is an advantage that the larger the number of the insertion holes 24′, the easier the adjustment of the inclination of the advertisement frame 30.

In other words, although it is most preferable that the advertisement frame 30 is standardized, the size of the advertisement frame 30 may be formed larger or smaller according to the object for advertisement or publicity, and at this time, since it is preferable that the inclination adjustment of the advertisement frame 30 can be freely done to maintain the angle of the advertisement frame easily noticed by the traveling cars or the pedestrians, if the number of the insertion holes 24′ drilled at the slider 24 is large, the inclination adjustment of the advertisement frame 30 can be done with a variety of angles.

In addition, the advertisement frame 30 is formed with insertion parts 32a, 32a′ by bending the upper end and the lower end of a support panel 32 so as to mount the advertisement plate 30a having an advertisement phrase, picture, mark, photograph and the like by pushing the advertisement plate from side to side, and insertion rods 31, 31′ are provided at the lower side of the support panel 32 so as to be inserted and fixed into the insertion holes 22 formed at the insertion rack body and the insertion holes 24′ formed at the slider 24, and a latch protrusion 33a and a fixing hole 33b are formed at the lower part of the insertion rods 31, 31′, so that when the insertion rods are inserted into the insertion holes 22 and the insertion holes 24′, the latch protrusion 33a is latched at the upper part of the insertion holes 22, 24′ so that the insertion rods 31, 31′ are stably supported, and at this time a pin is inserted and fixed into the fixing hole 33b which penetrates the insertion holes 22, 24′ and is exposed downward so that the advertisement frame 30 is not flown away or damaged by the wind or external impact.

In addition, if an insertion rack 40 having plural insertion holes 41 is further mounted at the back side of the insertion part 32a of the advertisement frame 30, the flower decoration including a variety of artificial flowers can be done depending on the seasons or a variety of flags can be inserted into the insertion holes so as to more efficiently perform the advertisement or publicity of the activities.

In particular, when the insertion holes 21, 22 of the insertion rack 20 and the insertion holes 41 of the insertion rack 40 are formed, if the upper hole is made wide and the lower hole is made narrower than the upper hole, the flower decoration including the artificial flowers can be more stably done.

Meanwhile, if the sliders 24 are installed at both sides of the insertion rack 20 and the advertisement frame 30 is installed so as to be noticed by the cars coming from one travelling direction lane as well as the cars coming from the opposite lane, then the advertisement frame 30 can be easily noticed by the driver or the passenger of the car coming and going as well as the pedestrian so as to maximize the efficiency of the publicity and advertisement, and if the publicity device 100 is installed above a center division pedestal, then the contents of publicity can be recognized more naturally and conveniently by the passengers and the drivers of the travelling cars in both directions.

Furthermore, when the publicity device 100 of the present invention is installed at a place installed with a guide rail G, if a fix hanger 25 which can be inserted into and connected to the upper end of the guide rail G is further provided at both sides of the front surface of the insertion rack 20 and is settled at the upper end of the guide rail G and connected and fixed by bolt or rivet, the publicity device 100 can be installed more secure.

In addition, as can be seen in FIG. 3, if a pair of connection pipes 23 are integrally formed with the slide pipes 23a so as to be moved left and right and holes 23h, 10a which are opened to each other are drilled and connected and fixed by connection member 23 composed of bolt and nut, then in the process of installing the pair of support pipes 10, 10′, even if a difference occurs in the spacing, the connection pipes 23 can be brought to be consistent to the support pipe 10, 10′ by adjusting the slide pipe 23a so that the support pipes can be very rapidly and conveniently assembled and mounted secure.

In addition, in this case, as can be seen in FIG. 7, if the connection pipes 23 are hinged to the slide pipes 23a so as to make possible the adjustment of the angle of the connection pipes 23, then the support pipes 10, 10′ can be installed to be inclined at an inclined roadside or the like and the insertion rack 20 can be maintained to be horizontal.

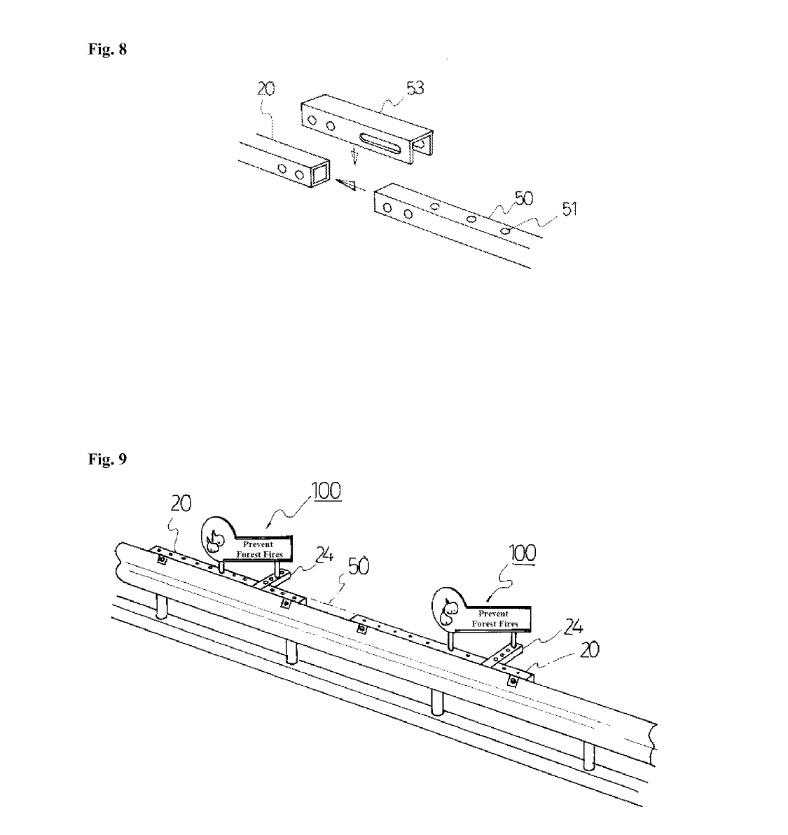

Meanwhile, when the publicity devices 100 of the present invention are installed at the roadside with a predetermined spacing, it is preferable that a separate connection rack 50 having plural insertion holes 51 is provided between the insertion rack 20 and the insertion rack 20 so as to connect the publicity device 100 and the publicity device 100 as shown in FIG. 8, and at this time, if the insertion rack 20 and the connection rack 50 are connected with a connection piece 52 such as a rectangular connection pipe or a shape socket and the like or with a socket 53 which is made by enlarging both ends of the connection rack 50, and when connecting by using the connection piece 52 or the socket 53, the connection is done by bolt, nut or riveting, and a variety of plants or artificial flowers are inserted into the insertion holes 51 of the connection rack 50, then the effect of road beautification and advertisement becomes significantly excellent.

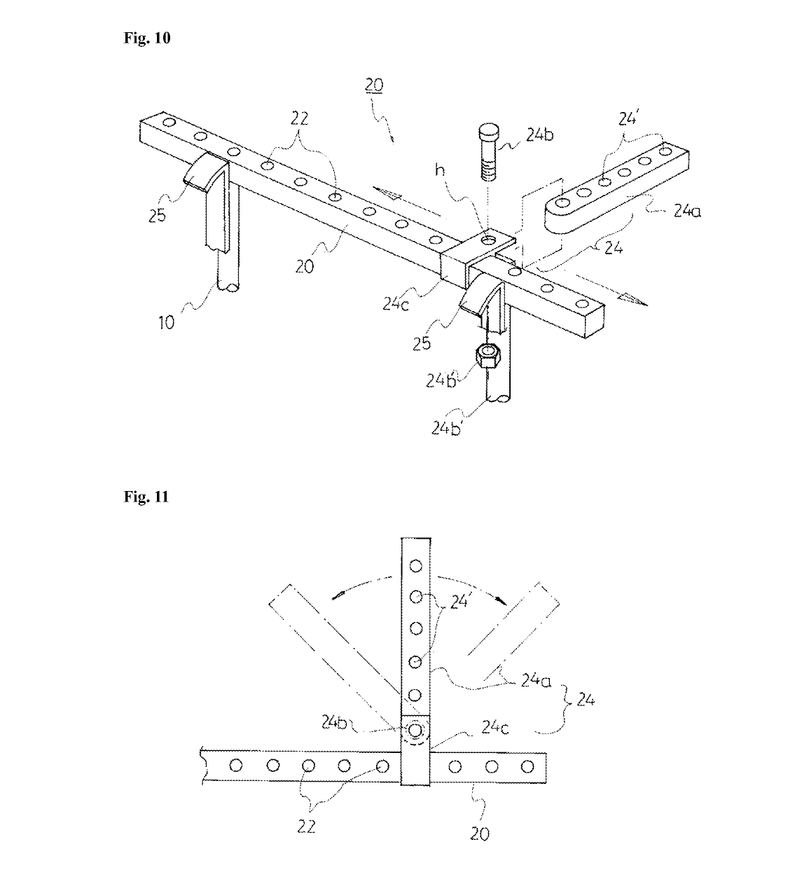

FIGS. 10 and 11 show a second embodiment of the present invention, and wherein FIG. 10 is a main part exploded perspective view of the insertion rack, and FIG. 11 is a top view exemplary drawing showing an action condition of the insertion rack.

As can be seen in FIGS. 10 and 11, in the present invention, the slider 24 which is moved left and right and adjusted along the insertion rack 20 is divided into a transfer rack 24c and a support bar 24a, and the support bar 24a is assembled to a hinge hole h of the transfer rack 24c by bolt 24b and the nut 24b′, so that the advertisement frame 30 can be easily fixed and installed by easily adjusting the slider 24 according to the size of the advertisement frame 30.

Describing the structure of the slider 24 in more detail, the slider 24 is divided into the support bar 24a having plural insertion holes 24′, and the transfer rack 24c at which a hinge hole h is drilled so that the forward end of the support bar 24a is inserted and assembled with bolt 24b and nut 24b′, and which at the same time is moved left and right and adjusted along the insertion rack body, and the support bar 24a and the transfer rack 24c can be assembled with bolt 24b and nut 24b′, so that the support bar 24a can be angularly adjusted left and right with the bolt 24b as a center of rotation.

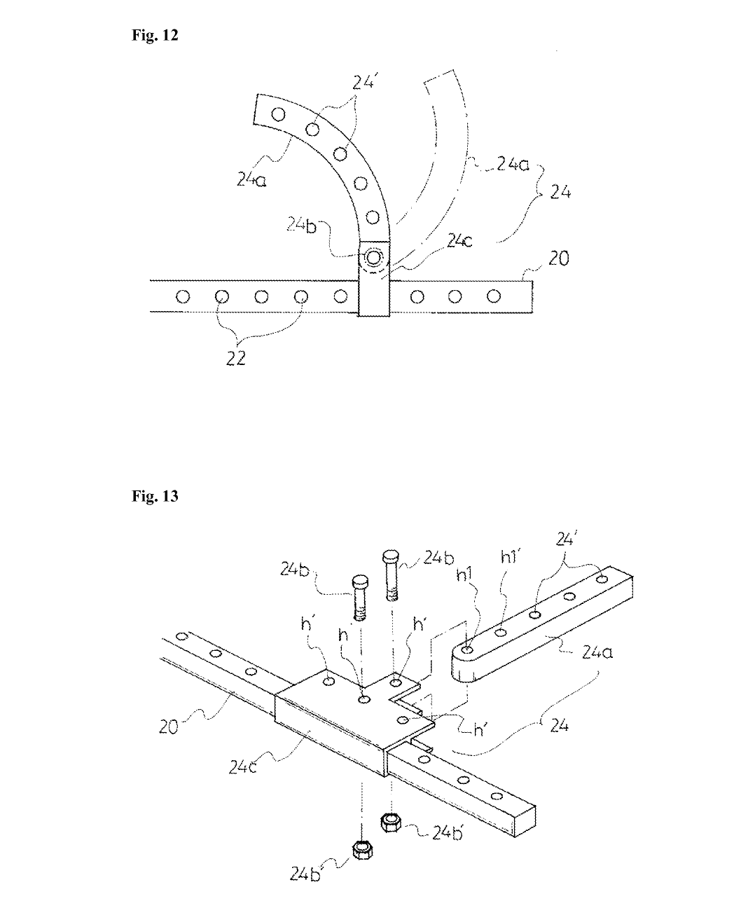

In FIG. 12 showing the third embodiment of the present invention, the support bar 24a is formed in a round shape and this is also possible to be finely adjusted according to the size of the advertisement frame 30 or the spacing between the insertion rods 31 and the insertion rods 31′ installed at the bottom surface of the advertisement frame 30.

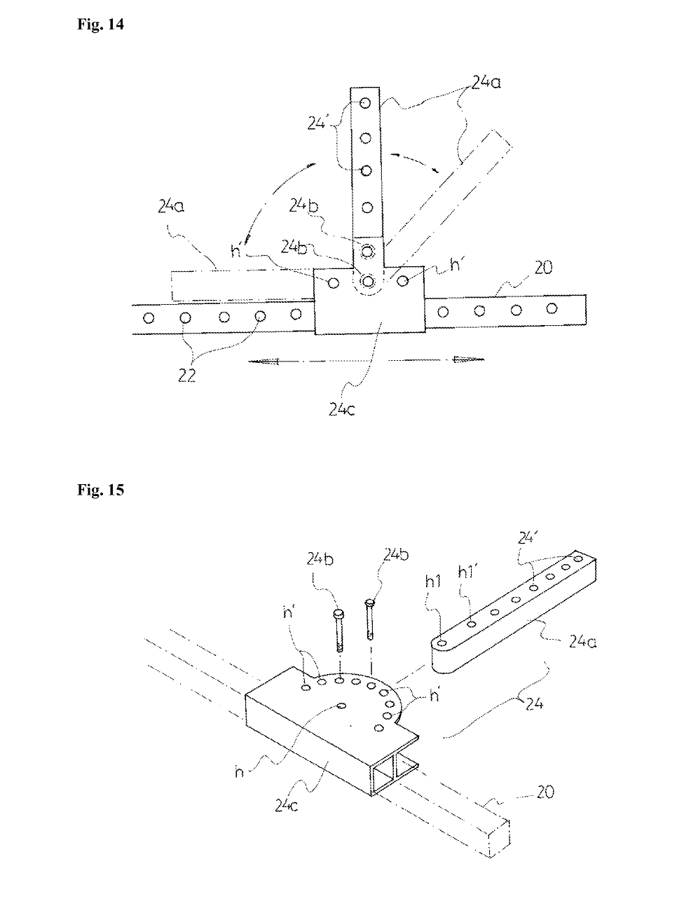

In FIGS. 13 and 14 showing the fourth embodiment of the present invention, the transfer rack 24c of the slider 24 is formed in “1” shape, and fix holes h′ for fixing the support bar 24a are drilled at the forward end and left and right parts with the hinge hole h formed at the center part as the center, and a hinge hole h1 which is assembled to the hinge hole h with bolt 24b and a fix hole h1′ consisting to the fix holes h′ are drilled at the support bar 24a, too, and the support bar 24a can be adjusted left and right with bolt 24b and nut 24b′ as the center and can be arranged parallel to the insertion rack 20 or in T shape by the fix holes h′, h1′, so that the installation angle can be variously adjusted and at the same time, when the support bar 24a is not used, it can be folded to be parallel to the insertion rack 20.

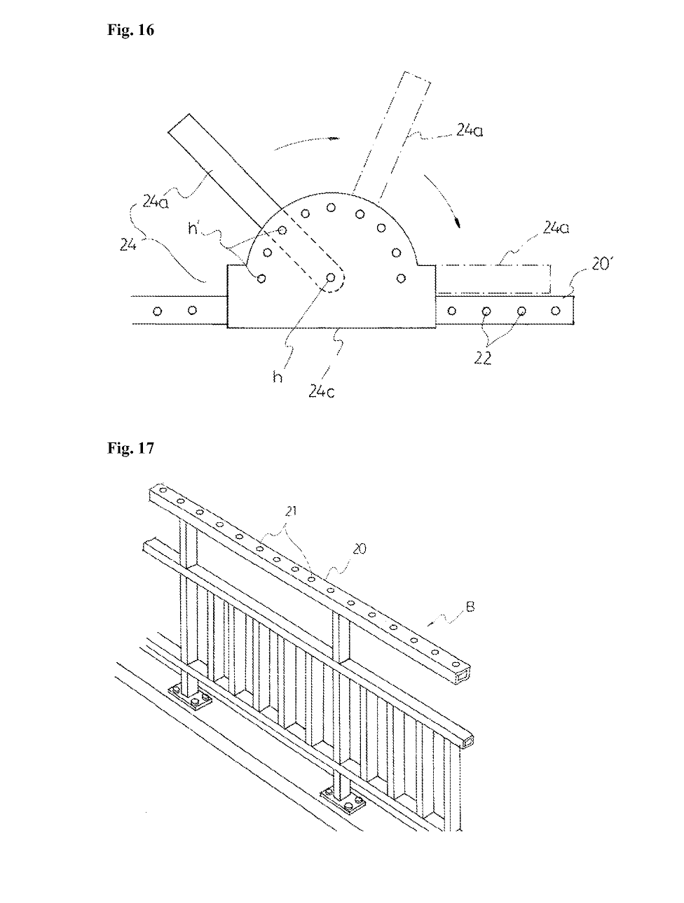

In FIGS. 15 and 16 showing the fifth embodiment of the present invention, the rear part of the transfer rack 24c of the slider 24 is formed in a form of circular arc, and plural fix holes h′ are formed in a form of circular arc with the hinge hole h formed at the center part as the center, and at the same time, a hinge hole h1 and a fix hole h1′ respectively consisting to the hinge hole h and the fix hole h′ are formed at the forward end of the support bar 24a so as to be angularly adjusted by bolt 24b and nut 24b′, and here also the installation angle can be variously adjusted and at the same time, when the support bar 24a is not used, it can be folded to be parallel to the insertion rack 20.

FIG. 17 shows the sixth embodiment of the present invention, wherein the insertion rack 20, which is in the form of rectangular shape and in which insertion holes 21 opening to each other are drilled at the upper surface and the lower surface or the insertion holes 21 are drilled in such a way that the size of the hole at the upper surface is large and the size of the hole at the lower surface is small, is constructed as upper pipe of rail of elevated road or as upper pipe of rail of bridge, and in this case, the artificial flower or natural flower, or various traffic guide indication plate or flange for activities can be directly inserted to the rail.

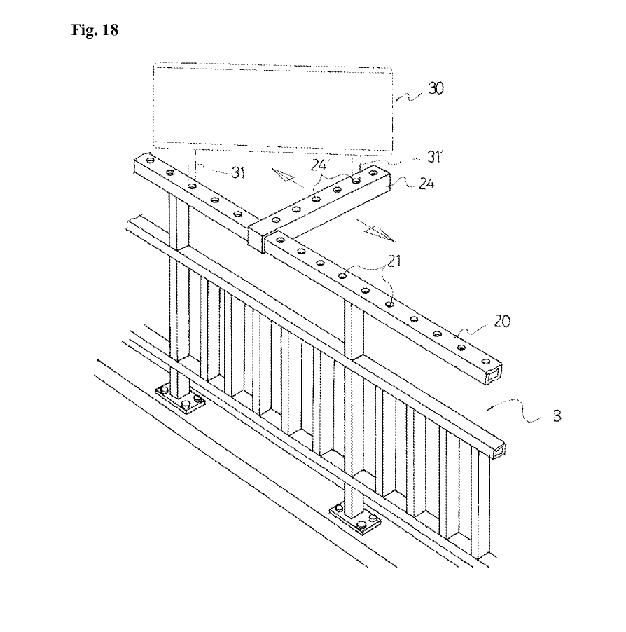

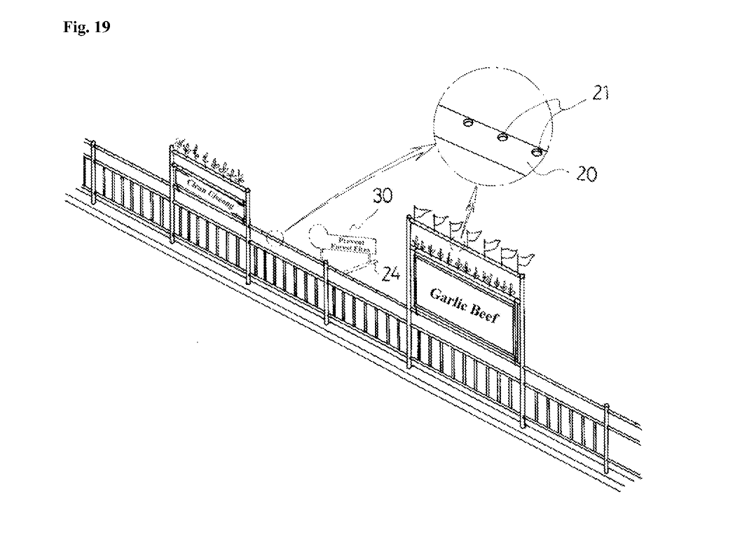

FIGS. 18 and 19 show the seventh embodiment of the present invention, wherein in FIG. 18, the upper pipe installed at the rail of elevated road or at the rail of bridge is formed as the insertion rack 20 having large and small insertion holes 21 at its upper surface and its lower surface, and a slider 24 having plural insertion holes 24′ is mounted at the insertion rack body, so that the advertisement frame 30 can be installed by moving left and right the slider 24 according to the distance between the insertion rods 31 and the insertion rods 31′ provided at the advertisement frame 30, and FIG. 19 shows a transformation of FIG. 18.

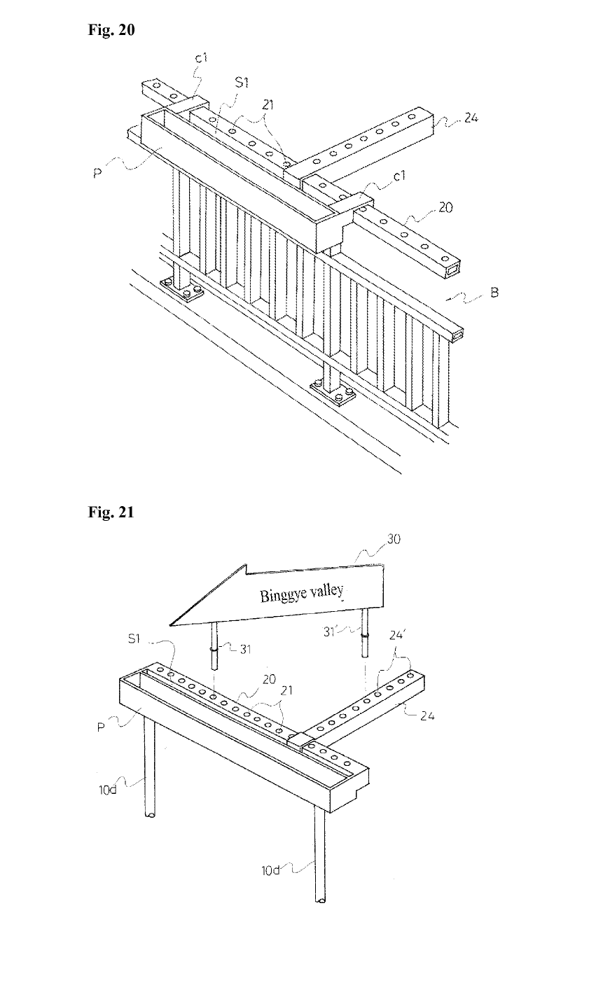

FIG. 20 is a perspective view showing the eighth embodiment of the present invention, wherein a flowerpot P is installed at the insertion rack 20 installed as an upper pipe of the bridge rail B so as to plant ornamental trees including herbaceous flowering plants, and the flowerpot P is connected and installed by using the connection rack c1, so that a slide recess S1 is naturally formed between the flowerpot P and the bridge rail Bused as the upper pipe of the bridge rail B, the movement adjustment of the slider 24 can be accomplished, and accordingly the planting of the plant and at the same time the publicity of the road or activity guide can be done by inserting the advertisement frame 30 such as various indication plate, or the guide plate or publicity plate.

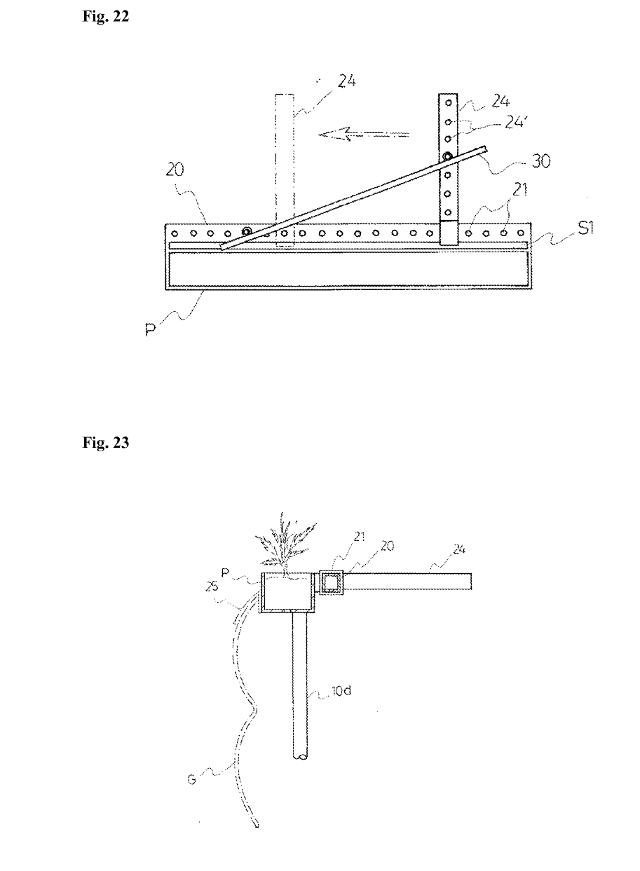

FIGS. 21 to 23 are perspective views showing the ninth embodiment of the present invention, wherein the insertion rack 20 and the flowerpot P are composed integrally, and the slide recess S1 is formed between the insertion rack 20 and the flowerpot P, and support pipes 10d are provided at the bottom of the flowerpot P body or the fix hanger 25 is further provided so as to be able to be hung to the guard rail G at both sides of the front surface, the advertisement frame can be installed by using the support pipes 10d in the area where there is no guard rail or rail and can be securely and stably fixed and installed at the guard rail G by using the fix hanger 25 in the area where guard rail G is installed.

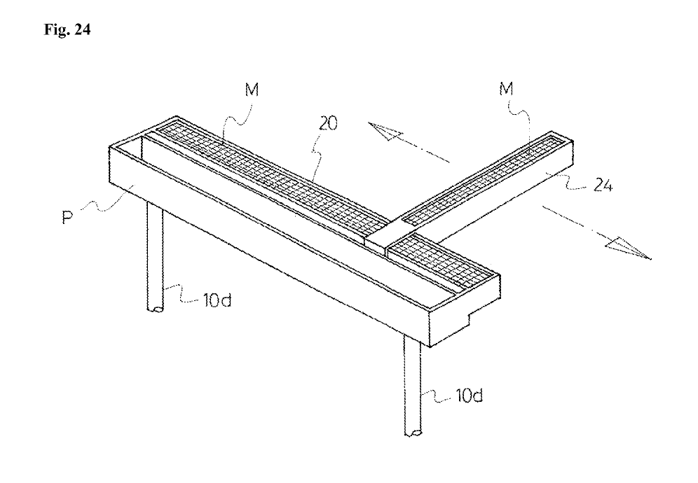

In FIG. 24 showing the tenth embodiment of the present invention, a net M is installed at the upper surface and the lower surface of the insertion rack 20 and the slide 24, so that the artificial flower, natural flower, the guide plate 30c or insertion rods 31, 31′ of the support panel 32 can be stably inserted into the mesh hole formed at the net M.

The present invention composed as such is not limited to the embodiments described above, and various changes may be made within the scope of the movements, purposes and thoughts of the present invention.

What is claimed is:

1. A device for bridge rails or roadside decorations and publicity, wherein the publicity device 100 comprises:
a support pipe 10 vertically installed by a concrete c by digging the earth to a predetermined depth;
an insertion rack 20 connected and fixed to the upper end of the support pipe 10 for inserting an advertisement frame or a safety indication plate or a direction indication plate; and
an advertisement frame 30 able to be inserted into the insertion rack 20 while being inserted with a publicity plate or an advertisement plate 30a,
wherein at the insertion rack 20, plural insertion holes 21 consistent with each other at the upper surface and the lower surface of the insertion rack body in the form of rectangular pipe so as to insert artificial flowers and the like, and insertion holes 22 for inserting insertion rods 31 of the advertisement frame 30 are drilled at the upper surface and the lower surface, and connection pipes 23 which can be connected to the upper end of the support pipe are formed at both sides of the bottom surface of thereof, and a slider 24 sliding transferred along the insertion rack 20 and having insertion holes 24′ for inserting insertion rods 31′ of the advertisement frame 30 is installed, and
wherein the advertisement frame 30 is provided, at the lower side of the support panel 32 having upper and lower insertion parts 32a, 32a′ so as to insert the advertisement plate 30a formed in a predetermined shape by pushing the advertisement plate from side to side, with insertion rods 31, 31′ to be inserted into the insertion holes 22 formed at the insertion rack body and the insertion holes 24′ formed at the slider 24, and a latch protrusion 33a and a fixing hole 33b are formed at the lower part of the insertion rods 31, 31′, so that the insertion rods are inserted into the insertion holes 22 and the insertion holes 24′ and thereafter a pin is inserted into the fixing hole 33b whereby the publicity device is stably assembled.

2. The device for bridge rails or roadside decorations and publicity of claim 1, wherein the insertion rack 20 formed in a rectangular pipe and perforated with plural insertion holes 21 for inserting artificial flowers, natural flowers or the insertion rods 31 of the advertisement frame 30 is installed and used as an upper pipe of a bridge rail B.

3. The device for bridge rails or roadside decorations and publicity of claim 1, wherein when the sliders 24 having plural insertion holes 24′ at both sides of the insertion rack are installed at one roadside or a center division pedestal, the advertisement plate 30a can be noticed by the cars coming from one travelling direction lane as well as the cars coming from the opposite lane.

4. The device for bridge rails or roadside decorations and publicity of claim 1, wherein connection pipes 23 mounted at the insertion rack 20 are integrally formed with the slide pipes 23a so as to be moved left and right and holes 23h, 10a which are opened to each other are drilled and connected and fixed by connection member 23 composed of bolt and nut, so that the slide pipe 23a is adjusted according to the installation spacing of the pair of support pipes 10, 10′ so as to be easily assembled and mounted at the support pipes 10, 10′.

5. The device for bridge rails or roadside decorations and publicity of claim 4, wherein the connection pipes 23 are hinged to the slide pipes 23a so as to be able to be adjusted and installed according to the installation angle of the support pipes 10, 10′.

6. The device for bridge rails or roadside decorations and publicity of claim 1, wherein a fix hanger 25 which can be inserted into and connected to the upper end of the guide rail G is further provided at both sides of the front surface of the insertion rack 20.

7. The device for bridge rails or roadside decorations and publicity of claim 1, wherein an insertion rack 40 having plural insertion holes 41 for inserting the artificial flower is further mounted at the back side upper end of the advertisement frame 30.

8. The device for bridge rails or roadside decorations and publicity of claim 1, wherein when the insertion holes 21, 22 of the insertion rack 20 and the insertion holes 41 of the insertion rack 40 are formed in such a way that the upper hole is made wide and the lower hole is made narrow.

9. The device for bridge rails or roadside decorations and publicity of claim 1, wherein at the time of installing at the roadside, a connection rack 50 having plural insertion holes 51 is provided between the insertion rack 20 and the insertion rack 20.

10. The device for bridge rails or roadside decorations and publicity of claim 9, wherein the insertion rack 20 and the connection rack 50 are connected with a connection piece 52 such as a rectangular connection pipe or a shape socket and the like or with a socket 53 which is made by enlarging both ends of the connection rack 50, and when connecting by using the connection piece 52 or the socket 53, the connection is done by bolt, nut or riveting.

11. The device for bridge rails or roadside decorations and publicity of claim 3, wherein the slider 24 is composed of the support bar 24a having plural insertion holes 24′, and the transfer rack 24c at which a hinge hole h is drilled so that the forward end of the support bar 24a is inserted and assembled with bolt 24b and nut 24b′, and which at the same time is moved left and right and adjusted along the insertion rack body, so that the support bar 24a can be angularly adjusted left and right with the bolt 24b as a center of rotation.

12. The device for bridge rails or roadside decorations and publicity of claim 10, wherein the support bar 24a is formed in a round shape.

13. The device for bridge rails or roadside decorations and publicity of claim 11, wherein the transfer rack 24c of the slider 24 is formed in “⊥” shape, and fix holes h′ for fixing the support bar 24a are drilled at the forward end and left and right parts with the hinge hole h formed at the center part as the center, and a hinge hole h1 which is assembled to the hinge hole h with bolt 24b and a fix hole h1′ consisting to the fix holes h′ are drilled at the support bar 24a, too, and the support bar 24a can be adjusted left and right with bolt 24b and nut 24b′ as the center and can be arranged parallel to the insertion rack 20 or in T shape by the fix holes h′, h1′.

14. The device for bridge rails or roadside decorations and publicity of claim 13, wherein the rear part of the transfer rack 24c of the slider 24 is formed in a form of circular arc, and plural fix holes h′ are formed in a form of circular arc with the hinge hole h formed at the center part as the center, and at the same time, a hinge hole h1 and a fix hole h1′ respectively consisting to the hinge hole h and the fix hole h′ are formed at the forward end of the support bar 24a so as to be angularly adjusted by bolt 24b and nut 24b′.

15. The device for bridge rails or roadside decorations and publicity of claim 2, wherein the insertion rack 20 used as a transverse bar of the bridge rail B is in the form of a hexagonal or circular pipe.

16. The device for bridge rails or roadside decorations and publicity of claim 15, wherein the insertion rack 20 is filled with foam urethane or styrofoam therein.

17. The device for bridge rails or roadside decorations and publicity of claim 1, wherein flowerpots P are connected by using a connection rack c1 and mounted at the insertion rack 20 installed as a transverse bar of the bridge rail B so as to plant ornamental trees including herbaceous flowering plants, so as to enable the planting of the plant and at the same time to enable the inserting of the advertisement frame 30 into which various indication plate, or the guide plate or publicity plate can be inserted.

18. The device for bridge rails or roadside decorations and publicity of claim 17, wherein the insertion rack 20 and the flowerpot P are composed integrally, and the slide recess S1 is formed between the insertion rack 20 and the flowerpot P, and support pipes 10d are provided at the bottom of the flowerpot P body or the fix hanger 25 is provided so as to be able to be hung to the guard rail G at both sides of the front surface.

19. The device for bridge rails or roadside decorations and publicity of claim 1, wherein a net M is installed at the upper surface and the lower surface of the insertion rack 20 and the slide 24 so that the artificial flower, natural flower, the guide plate 30c or insertion rods 31, 31′ of the support panel 32 can be stably inserted and supported.

20. The device for bridge rails or roadside decorations and publicity of claim 2, wherein when the sliders 24 having plural insertion holes 24′ at both sides of the insertion rack are installed at one roadside or a center division pedestal, the advertisement plate 30a can be noticed by the cars coming from one travelling direction lane as well as the cars coming from the opposite lane.

21. The device for bridge rails or roadside decorations and publicity of claim 2, wherein the insertion rack 20 is filled with foam urethane or styrofoam therein.

22. The device for bridge rails or roadside decorations and publicity of claim 2, wherein flowerpots P are connected by using a connection rack c1 and mounted at the insertion rack 20 installed as a transverse bar of the bridge rail B so as to plant ornamental trees including herbaceous flowering plants, so as to enable the planting of the plant and at the same time to enable the inserting of the advertisement frame 30 into which various indication plate, or the guide plate or publicity plate can be inserted.

23. The device for bridge rails or roadside decorations and publicity of claim 2, wherein a net M is installed at the upper surface and the lower surface of the insertion rack 20 and the slide 24 so that the artificial flower, natural flower, the guide plate 30c or insertion rods 31, 31′ of the support panel 32 can be stably inserted and supported.
